(19) United States
(12) Patent Application Publication
(10) Pub. No.: US 2023/0257229 A1
(43) Pub. Date: Aug. 17, 2023

(54) ILLUMINATION DEVICE FOR AN ELEVATOR SYSTEM AND METHOD FOR ILLUMINATING AN ELEVATOR SHAFT

(71) Applicant: Inventio AG, Hergiswil (CH)

(72) Inventor: Martin Pfrunder, Gisikon (CH)

(21) Appl. No.: 18/003,162

(22) PCT Filed: Jun. 9, 2021
(86) PCT No.: PCT/EP2021/065447

§ 371 Date: Dec. 23, 2022

(30) Foreign Application Priority Data
Jun. 30, 2020 (EP) 20183197.1

(51) Int. Cl. B66B 3/00; B66B 5/00

(52) U.S. Cl. CPC B66B 3/002; B66B 5/0087; B66B 13/22

(57) ABSTRACT

An illumination device is used for illuminating an elevator shaft of an elevator system. The illumination device includes at least one light source and can illuminate an elevator shaft of the elevator system such that the illumination device indicates at least two states of the elevator system. The light source emits a first light signal when the elevator system is in a first state and a second light signal when the elevator system is in a second state, and wherein the difference between the first light signal and the second light signal is visible to a person in the elevator shaft.

### FIELD

The invention relates to an illumination device for an elevator system and a method for illuminating an elevator shaft of an elevator system, and to an elevator system which has such an illumination device or is controlled by the aforementioned method.

### BACKGROUND

In elevator systems which have an elevator car in an elevator shaft, the elevator car moves between different floors (foyers) of a building in order to transport passengers. The elevator shaft is illuminated at least during maintenance or inspection. It is known that light-emitting diodes (LED) or light-emitting diode strips are used as shaft illumination. A counterweight, which is connected to the elevator car via a suspension means, travels toward the moving elevator car and normally past the elevator car at about half the height of the elevator shaft. Since a technician often has to work on the roof of the elevator car or in a shaft pit in the elevator shaft during maintenance or fitting work on the elevator system, the counterweight could strike the technician. Therefore, in this case, a collision must be avoided as far as possible. A technician in the elevator shaft must therefore be constantly informed whether the elevator car is currently being put into a normal mode or a maintenance operating mode for moving, or whether the counterweight is about to approach the elevator car. In addition, in order to be able to guarantee the safety of passengers or service personnel, many safety-relevant components in the elevator system have to be monitored in order, for example, to then be able to operate or control the elevator system in a suitable and safe manner. A large number of sensors or switches are therefore used, with the aid of which signals or information can be used by the technician in the elevator shaft to monitor the current states of the safety-relevant components. If one of these components fails, the elevator system is immediately taken out of service or operated with limited functions.

A safety-relevant component is, for example, a shaft door which is only opened at a floor when the elevator car arrives at this floor. At each shaft door is a door contact switch which is closed as long as the shaft door is closed and remains open as long as the shaft door is open. The elevator car can move when this door contact switch is closed again. If a door contact switch is opened or not closed properly, the elevator car can no longer run. Such a door contact switch must therefore be constantly monitored, and its state must be reported immediately to a technician in the elevator shaft so that he can find out whether the elevator car can currently be moved, whether all shaft doors are currently closed properly, or whether someone could have entered the elevator shaft through a shaft door.

### SUMMARY

There may be a need, among other things, to avoid a dangerous scenario as far as possible using an intuitive warning, and to be able to easily monitor safety-relevant components such as shaft doors of an elevator system at all times, especially during fitting and maintenance work.

Such a need can be met by the subject matter of any of the advantageous embodiments defined in the following description.

According to the invention, an illumination device for an elevator system is proposed, wherein the illumination device has at least one light source. The illumination device can illuminate an elevator shaft of the elevator system in such a way that the illumination device can indicate at least two states of the elevator system. In this case, the light source can generate a first light signal when the elevator system is in a first state. For this purpose, it can emit a second light signal when the elevator system is in a second state, wherein the difference between the first and the second light signal is visible, namely to the human eye. The first state is, for example, a normal operating mode of the elevator system, while the second state is an inspection operating mode or an emergency operating mode of the elevator system. Alternatively or additionally, the illumination device can also indicate at least a first switching state and a second switching state of a safety element of the elevator system. Such a safety element is, for example, a switch, a controller, or a sensor, etc. of the elevator system.

According to an advantageous embodiment of the invention, the safety element is a shaft door switch of the elevator system, wherein the first switching state signifies that the shaft door of the elevator system is open, while the second switching state indicates that the shaft door of the elevator system is closed, so that the state, in particular opening and closing, of the shaft door can be monitored at all times by a light signal.

According to an advantageous embodiment of the invention, the first light signal and the second light signal can be emitted in different colors. Particularly advantageously, the light source will change its light color on the basis of an operating state of the elevator system. The light source can comprise one or more light-emitting diodes (LEDs), or, in particular, can be designed as a strip of several light-emitting diodes, wherein the LEDs can emit different colors. The strip will, for example, extend continuously in one piece or in several pieces along an elevator shaft. Since LEDs have a low electrical power consumption (e.g. energy efficiency class A+), they generate little heat loss and allow a high degree of flexibility in terms of color selection. The light radiated by an LED has a specific wavelength and therefore a specific color. Normally, an LED only radiates a single-color light signal. Even if some LEDs can change their light color, for example by changing an input voltage, the light color is limited to a very narrow wavelength range. Thus, as a rule, it is preferable to use a plurality of LEDs which radiate different light colors. By controlling the respective LEDs to turn on and off at a specific time, the light source can radiate any color or a particular combination of colors. Using different colors and illumination times, a color code is applied to flexibly represent different situations or levels of danger on the basis of different light signals. In addition to saving energy, LEDs have other advantages over various illumination means, since the low operating temperature of LEDs associated with low power consumption increases the service life of the light source. The cost of purchase and the corresponding fitting outlay can thus be reduced. Furthermore, LEDs have a large radiation angle, which contributes to good illumination of the elevator shaft and at the same time reduces dazzling of the eyes, even when looking directly at the LEDs.

According to a further advantageous embodiment, the illumination device has, for example, an alarm comprising an optical sensor, wherein the optical sensor can detect the first light signal and/or the second light signal. The alarm can generate an alarm signal corresponding to the first state and/or second state of the elevator system on the basis of the detected first light signal and/or the second light signal. The alarm signal can be generated as an acoustic signal or as a visual signal in one or more specific colors, as a result of which the alarm signal can be perceived immediately by people in the elevator shaft. If the alarm signal is in the form of a visual signal, the alarm signal can also be generated by the illumination device. In this case, the illumination device is also considered to be an alarm or the alarm is considered to be integrated in the illumination device since e.g. some LEDs of the illumination device will no longer act as, or will not only act as, a light source for illuminating the elevator shaft, but as a light alarm for alerting a technician in the elevator shaft. Since the illumination device mainly has to illuminate the elevator shaft, the color arrangements for the light signals of the illumination device and the visual alarm signal are defined differently independently of one another; for example, the alarm signal is defined according to IEC (International Electrotechnical Commission) standards. A color arrangement for the light signals of the illumination device is explained in detail below by means of embodiments.

According to a further advantageous embodiment, another possibility for increasing the warning effect of the illumination device is for the illumination device to be able to be configured and controlled by a control unit of the elevator system so that the light source of the illumination device can illuminate the elevator shaft in accordance with a customer requirement. Such a configuration can be implemented either automatically by the control unit, e.g. according to a schedule, or by manual actuation of the control unit.

According to a further advantageous embodiment, the illumination device can be supplied using two separate power supply circuits, wherein a first power supply circuit is connected to a public power grid and wherein a second power supply circuit has an electrical energy store. The electrical energy store is, for example, a battery unit or a UPS system, i.e. an uninterruptible power supply. If the first power supply circuit fails, the second power supply circuit is switched on immediately and seamlessly continues to supply power to the illumination device. The illumination device can therefore continue to illuminate the elevator shaft even in an emergency, e.g. in the event of a power failure, usually with a weaker light.

A method for illuminating an elevator shaft of an elevator system is also provided, in which method the elevator shaft is illuminated by at least one light source in such a way that a first light signal is emitted by the light source when the elevator system is in a first state and a second light signal is emitted by the light source when the elevator system is in a second state, and wherein the first light signal and the second light signal are visually distinguishable from each other.

Furthermore, an elevator system is proposed which has at least one illumination device as described above or which can be controlled by the aforementioned method.

It should be noted that some of the possible features and advantages of the invention are described herein with reference to various embodiments, both of the illumination device and of a method for illuminating an elevator shaft of an elevator system. A person skilled in the art will recognize that the features can be suitably combined, adapted, or replaced in order to arrive at further embodiments of the invention.

Embodiments of the invention will be described below with reference to the accompanying drawings; neither the drawings nor the description should be interpreted as limiting to the invention.

### DESCRIPTION OF THE DRAWINGS

In the drawings:

FIG. 1 is a schematic view of an elevator system according to the invention; and

FIG. 2 is a schematic view of an illumination device according to the invention.

### DETAILED DESCRIPTION

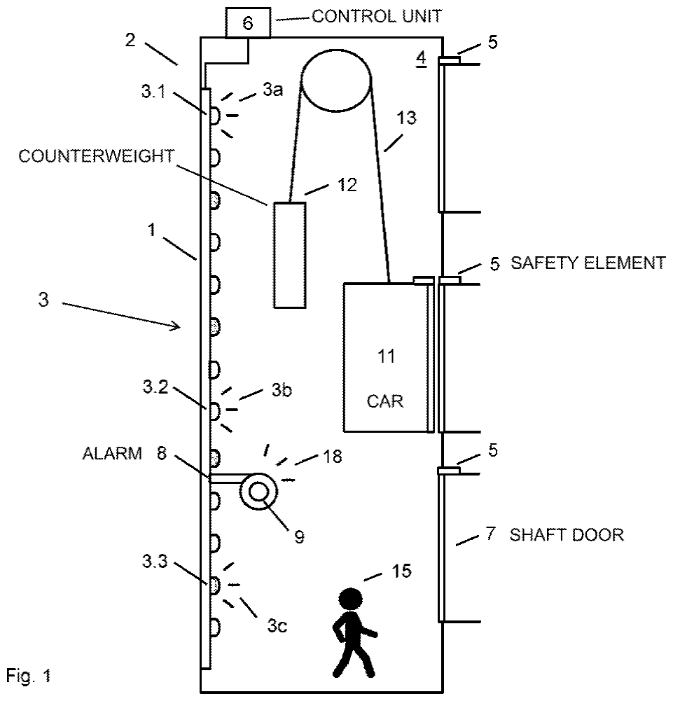

FIG. 1 shows an elevator system 2. A counterweight 12 and an elevator car 11 are suspended by a suspension means 13 in an elevator shaft 4 of the elevator system 2. During operation, the elevator car 11 moves vertically in the elevator shaft 4 and the counterweight 12 executes an opposite movement.

In order to illuminate the elevator shaft 4, there is an illumination device 1 for the elevator system 2, the illumination device 1 being provided with at least one light source 3. In this embodiment, the illumination device 1 comprises e.g. three light sources 3.1, 3.2, and 3.3, which are each shown in white, gray (light shading), and dark gray (dark shading) in FIG. 1. Each light source comprises a plurality of light-emitting diodes (LEDs). The light sources 3 or the LEDs thereof form an LED strip which, for example, extends in one piece over the entire shaft height, namely from the shaft ceiling to the shaft pit of the elevator shaft 4. However, a plurality of LED strips can also be provided, each of which is, for example, 10 to 20 meters long and equipped with a shaped plug and/or connection plug at the end.

For example, a first light source 3.1 illuminates the elevator shaft 4 with a first light signal 3a when the elevator system 2 is put into a normal operating mode, while a second light source 3.2, which can generate a second light signal 3b, lights up when the elevator system 2 is in an inspection mode. Furthermore, using the two light sources 3.1, 3.2 and with the aid of a further light source 3.3, a different state of the elevator system 2 or a switching state of a safety element 5 of the elevator system 2 can be displayed. The safety element 5 can be a switch, a sensor, or a control unit, which is responsible for a safety-relevant function of the elevator system 2. A typical example of a safety element 5 is a shaft door switch of the elevator system 2. By determining a switching state of the switching door switch 5, it is possible to find out current information about an open or closed shaft door 7 of the elevator system 2.

The light signals 3a, 3b, 3c can be emitted as different colors. The colors are changed when an operating state changes or when a safety element 5 of the elevator system 2 is switched. The light source 3 or the LED strip is equipped with a plurality of LEDs which can emit different colors. In addition to a flexible choice of color, the first light source 3.1 can either be switched off or remain switched on when another light source 3.2 or 3.3 is switched on. This also applies analogously to the second light source 3.2 or the third light source 3.3. For this purpose, the illuminating duration or flashing duration of the light source 3 can be adjusted with regard to different dangerous situations in order to increase the warning effect of the illumination device or to expand the situations which require warning. Specific examples of this are given in the following Table I.

In one embodiment, the illumination device 1 will alternately emit light signals in white and orange by switching the first light source 3.1 and the second light source 3.2 on and off one after the other. The white light signal 3a and the orange light signal 3b can be emitted for the same or different time periods and/or in the same or different quantities, as a result of which the light signals 3a, 3b can be read as a light code. The alternately flashing white and orange light signals 3a, 3b indicate a danger; specifically, when the time period is the same, they signify that the counterweight 12 is approaching the elevator car 11 when someone is present in the elevator shaft 4. The presence of the person 15 in the shaft is determined, for example, by the shaft door contact 5 of a shaft door 7 or by a manually operated unlocking key (not shown), which is normally located outside the elevator shaft 4. If the white and the orange light signals 3a, 3b are emitted at the same time but in different quantities, e.g. all three orange light signals and one white signal, it signifies, for example, that the elevator car 11 is moving upward toward the top floor when a person 15 is on the car roof. The more orange signals there are, the more urgent the warning that the elevator car 11 is approaching the top floor. If the white and orange light signals 3a, 3b have different time periods, the warning displayed indicates that the elevator car 11 is moving downward toward the lowest floor while a person is in the pit, for example. The faster the orange signal flashes, the more urgent the warning that the elevator car 11 is getting closer and closer to the lowest floor. A different combination (e.g. sequence) of the light signals 3a, 3b can indicate a different situation. The table below shows, in detail but non-exhaustively, examples of other possible warnings or information that can be displayed by the LED strip.

TABLE I

| Color | Illumination | Information | Meaning |
|---|---|---|---|
| Red | Continuous | Unsafe or | Entry of personnel into the shaft |
| | | improper | detected by the shaft door contact |
| | | use | without an inspection stop switch |
| | | | or emergency stop switch being |
| | | | actuated. |
| | | | Person in shaft during normal |
| | | | operation |
| White | Flashing | Alarm | Malfunction |
| and red | alternately | | |
| White | Flashing | Warning | Person on the car roof and car |
| and | alternately | | approaching the top floor |
| orange | | | Person in the shaft pit and car |
| | | | approaching the lowest floor |
| | | | Counterweight travelling past |
| | | | the car |
| White | Flashing | Message | Person in the shaft and a |
| | | | temporary security |
| | | | system is activated |
| White | Flashing | Message | Elevator blocked and |
| and | alternately | | emergency call actuated |
| green | | | |
| White | Continuous | Safe | Illumination device is switched |
| | | operation | on and an emergency stop |
| | | | switch in the shaft or engine |
| | | | room is activated |

In addition, the first and third light sources 3.1 and 3.3 can generate the light signals 3a and 3c so as to be white flashing light signals when a person 15 is in the elevator shaft 4 and a temporary safety device (not shown) of the elevator system 2 is activated. Such a safety device, e.g. as an additional brake or a safety support, e.g. a shock stop, can limit available car movement at the top and bottom of the elevator shaft 4 in order to keep a sufficient safety space free.

Furthermore, the illumination device 1 has an alarm 8 comprising an optical sensor 9. The optical sensor 9 can detect a light code represented by the light signals 3a, 3b, 3c. The alarm 8 can decode the light code. If a detected light code represents a dangerous situation, an alarm signal 18 is generated. The alarm signal 18 is generated as an acoustic signal and/or a visual signal in order to directly alert the people 15 in the elevator shaft 4 or on the elevator system 2 of a corresponding dangerous situation. An acoustic signal can be an audio signal or a voice signal. If the alarm signal is a visual signal, the alarm 8 can also use the light source 3 or can be formed by part of the LED strip.

In this embodiment, the alarm signal 18 is a visual signal generated in one or more specific colors. The colors of the alarm signal 18 are defined e.g. according to IEC (International Electrotechnical Commission) standards, as is usual; their possible meanings are shown in a Table II below:

TABLE II

| Color | Situation/state | Meaning | Measure |
|---|---|---|---|
| Green | Normal | Normal state | None |
| Yellow | Abnormal | Abnormal state, | Monitor or intervene |
| | | critical condition | (e.g. by restoring the |
| | | imminent | intended function) |
| Red | Emergency | Dangerous state | Immediate intervention to |
| | | | remedy dangerous state |
| Blue | Action | Indicates a state that | Mandatory intervention |
| | mandatory | requires operator | |
| | | intervention | |
| White | Neutral | Other states | Monitor |

In addition, the illumination device 1 can be configured or controlled automatically and/or manually by a control unit 6 of the elevator system 1. Since a sequence, the colors, and the switching on and off of the light sources 3 are adapted to the particular usage profile and freely selected, the illumination device 1 can illuminate the elevator shaft 4 in a color or style chosen by the customer.

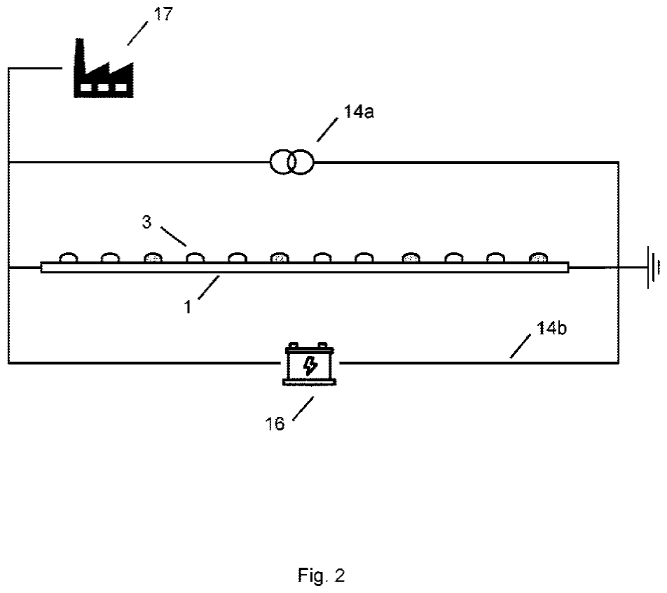

FIG. 2 shows that the illumination device 1 is supplied with two separate power supply circuits 14a and 14b, with a first power supply circuit 14a being connected to a public power grid 17, which can be designed as an independent circuit or can share a power supply circuit of the elevator system 1. At the same time, the illumination device 1 has a second power supply circuit 14b which is available in an emergency. The second power supply circuit 14b has an electrical energy store 16, which is, for example, a battery unit or a UPS system. The illumination device 1 continues to be supplied with the second power supply circuit 14b despite the failure of the first power supply circuit 14a, i.e. the power supply for the illumination device 1 is switched from the first power supply circuit 14a to the second power supply circuit 14b in an emergency without power interruption. In this case, not all LEDs 3 have to be supplied with electricity, and therefore the energy consumption of the illumination device can be reduced. In this case, it is sufficient if the elevator shaft 4 does not go dark, but continues to be illuminated with an emergency light, although the emergency light is weaker than a normal illumination light from the illumination device 1. A technician 15 can thus orient himself in an elevator shaft in the event of a power failure and take measures to free himself. This provides additional safety for the technician 15 whether he is in the shaft pit or on the car roof.

Finally, it should be noted that terms such as “having,” “comprising,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An illumination device for an elevator system, the illumination device comprising:
a light source adapted to illuminate an elevator shaft of the elevator system and indicate at least two states of the elevator system;
wherein the light source emits a first light signal when the elevator system is in a first of the two states and emits a second light signal when the elevator system is in a second of the states; and
wherein a difference between the first light signal and the second light signal is visible to a person.

17. The illumination device according to claim 16 wherein the first state is a normal operating mode of the elevator system and the second state is an inspection operating mode or an emergency operating mode of the elevator system.

18. The illumination device according to claim 16 wherein the light source indicates a first switching state and a second switching state of a safety element of the elevator system by emitting at least a third light signal.

19. The illumination device according to claim 18 wherein the safety element is a shaft door switch of the elevator system, wherein the first switching state signifies an open shaft door of the elevator system and the second switching state signifies that the shaft door is closed.

20. The illumination device according to claim 16 wherein the first light signal and the second light signal are emitted in different colors.

21. The illumination device according to claim 16 wherein the light source includes a plurality light-emitting diodes extending continuously along a height of the elevator shaft forming at least one strip of the light-emitting diodes.

22. The illumination device according to claim 16 including an alarm having an optical sensor, the optical sensor detecting the first light signal and/or the second light signal, and the alarm generating a first alarm signal corresponding to the first state of the elevator system when the first light signal is detected and generating a second alarm signal when the second light signal is detected.

23. The illumination device according to claim 16 adapted to be configured and controlled by a control unit of the elevator system.

24. The illumination device according to claim 16 including two separate power supply circuits, wherein a first of the power supply circuits is connected to a public power grid and a second of the power supply circuits has an electrical energy store.

25. An elevator system comprising:
an elevator shaft; and
an illumination device according to claim 16 extending over a height of the elevator shaft.

26. A method for illuminating an elevator shaft of an elevator system, the method comprising the steps of:
illuminating the elevator shaft with a light source emitting a first light signal when the elevator system is in a first state and emitting a second light signal when the elevator system is in a second state; and
emitting the first light signal and the second light signal to be visually distinguishable from each other to a person.

27. The method according to claim 26 wherein the first state is a normal operating mode of the elevator system and the second state is an inspection operating mode or an emergency operating mode of the elevator system.

28. The method according to claim 26 including emitting the first light signal when a safety element of the elevator system is in a first switching state and emitting the second light signal when the safety element is in a second switching state.

29. The method according to claim 26 including emitting the first light signal and the second light signal in different colors.

30. The method according to claim 26 including detecting the first light signal and/or the second light signal with an optical sensor, and generating an alarm signal corresponding to a one of the first state and the second state of the elevator system based upon the detected one of the first light signal and the second light signal.

31. An elevator system comprising:
an elevator shaft;
an illumination device extending over a height of the elevator shaft; and
wherein the illumination device is controlled by the method according to claim 26.
